(19) United States
(12) Patent Application Publication
(10) Pub. No.: US 2026/0089498 A1
(43) Pub. Date: Mar. 26, 2026

(54) RF SENSING AIDED USER ACTION PREDICTION

(71) Applicant: Robert Bosch GmbH, Stuttgart (DE)

(72) Inventors: Sushanta Mohan Rakshit, Milpitas, CA (US); Vivek Jain, Sunnyvale, CA (US)

(21) Appl. No.: 18/894,543

(22) Filed: Sep. 24, 2024

(51) Int. Cl. H04W 12/06; H04B 7/06; H04W 4/02; H04W 4/33; H04W 12/08

(52) U.S. Cl. CPC H04W 12/06; H04B 7/0626; H04W 4/027; H04W 4/33; H04W 12/08

(57) ABSTRACT

Sensor data streamed from a plurality of personal electronic devices worn by a user is received to a hub. A first analysis of the sensor data is performed using a first data fusion to determine instantaneous aspects of the movement of the user. A second analysis of the instantaneous aspects is performed using a second data fusion to determine behavioral aspects of the movement of the user over time. An actionable result according to the second analysis. One or more operations are performed based on the actionable result.

### TECHNICAL FIELD

Aspects of the disclosure generally relate to radio frequency (RF) sensing aided user interaction prediction.

### BACKGROUND

The use of personal wearable electronics is on the rise. At any point of time, a person may have several electronic devices, for example, earphones, a smart watch, a phone, a continuous glucose monitor or other vitals monitor, and/or shoes equipped with sensors.

### SUMMARY

In one or more illustrative examples, a method for performing data pooling and analysis, includes receiving, by a hub, sensor data streamed from a plurality of personal electronic devices worn by a user; performing a first analysis of the sensor data using a first data fusion to determine instantaneous aspects of the movement of the user; performing a second analysis of the instantaneous aspects using a second data fusion to determine behavioral aspects of the movement of the user over time; determining an actionable result according to the second analysis; and performing one or more operations based on the actionable result.

In one or more illustrative examples, the sensor data includes inertial measurement unit (IMU) data from one or more IMU sensors of the plurality of personal electronic devices.

In one or more illustrative examples, the IMU data includes acceleration and/or velocity information with respect to movement of the user.

In one or more illustrative examples, the sensor data includes radio frequency (RF) channel information data from one or more RF transmitters of the plurality of personal electronic devices.

In one or more illustrative examples, the RF channel information data indicates one or more of distances between pairs of the plurality of personal electronic devices and channel state information (CSI) representative of the environment between the plurality of personal electronic devices.

In one or more illustrative examples, the instantaneous aspects include one or more of user traits, posture, actions, and/or activities.

In one or more illustrative examples, the behavioral aspects include one or more of user intent determination and/or person identification.

In one or more illustrative examples, the actionable result including authorizing the user to access a device or location based on the user intent determination and the person identification.

In one or more illustrative examples, the plurality of personal electronic devices include one or more of headphones, a biometric device, a smart watch, and/or a mobile phone.

In one or more illustrative examples, the method further includes identifying, by the hub, the plurality of personal electronic devices based on advertisement messages sent by the respective personal electronic devices; receiving, to the hub, device information messages from the plurality of personal electronic devices, the device information messages indicating device-specific interfaces and capabilities of the respective personal electronic devices; and sending, by the hub, configurations to the plurality of personal electronic devices, the configurations indicating a cadence for receiving the sensor data and/or information on which elements of the sensor data is to be provided to the hub.

In one or more illustrative examples, the method further includes broadcasting, by the hub, a device query message broadcast requesting that the plurality of personal electronic devices send device sensor information messages to the hub; receiving, by the hub, the device sensor information messages requested from the plurality of personal electronic devices; and continuing to receive periodic device sensor information messages from the plurality of personal electronic devices.

In one or more illustrative examples, the plurality of personal electronic devices defer sending the periodic device sensor information messages if there is a conflict with protocol messages being sent or received by the plurality of personal electronic devices.

In one or more illustrative examples, a system for performing data pooling and analysis includes a plurality of personal electronic devices worn by a user; and a hub device, configured to: receive sensor data streamed from the plurality of personal electronic devices; perform a first analysis of the sensor data using a first data fusion to determine instantaneous aspects of the movement of the user; perform a second analysis of the instantaneous aspects using a second data fusion to determine behavioral aspects of the movement of the user over time; determine an actionable result according to the second analysis; and perform one or more operations based on the actionable result.

In one or more illustrative examples, the sensor data includes inertial measurement unit (IMU) data from one or more IMU sensors of the plurality of personal electronic devices.

In one or more illustrative examples, the IMU data includes acceleration and/or velocity information with respect to movement of the user.

In one or more illustrative examples, the sensor data includes radio frequency (RF) channel information data from one or more RF transmitters of the plurality of personal electronic devices.

In one or more illustrative examples, the RF channel information data indicates one or more of distances between pairs of the plurality of personal electronic devices and channel state information (CSI) representative of the environment between the plurality of personal electronic devices.

In one or more illustrative examples, the instantaneous aspects include one or more of user traits, posture, actions, and/or activities.

In one or more illustrative examples, the behavioral aspects include one or more of user intent determination and/or person identification.

In one or more illustrative examples, the actionable result including authorizing the user to access a device or location based on the user intent determination and the person identification.

In one or more illustrative examples, the plurality of personal electronic devices include one or more of headphones, a biometric device, a smart watch, and/or a mobile phone.

In one or more illustrative examples, the hub is further configured to identify, by the hub, the plurality of personal electronic devices based on advertisement messages sent by the respective personal electronic devices; receive, to the hub, device information messages from the plurality of personal electronic devices, the device information messages indicating device-specific interfaces and capabilities of the respective personal electronic devices; and send, by the hub, configurations to the plurality of personal electronic devices, the configurations indicating a cadence for receiving the sensor data and/or information on which elements of the sensor data is to be provided to the hub.

In one or more illustrative examples, the hub is further configured to broadcast, by the hub, a device query message broadcast requesting that the plurality of personal electronic devices send device sensor information messages to the hub; receive, by the hub, the device sensor information messages requested from the plurality of personal electronic devices; and continue to receive periodic device sensor information messages from the plurality of personal electronic devices.

In one or more illustrative examples, the plurality of personal electronic devices defer sending the periodic device sensor information messages if there is a conflict with protocol messages being sent or received by the plurality of personal electronic devices.

In one or more illustrative examples, one or more non-transitory computer-readable mediums include instructions for performing data pooling and analysis that, when executed by system including a hub device and a plurality of plurality of personal electronic devices, cause the system to perform operations including to capture sensor data streamed from a plurality of personal electronic devices worn by a user; perform a first analysis of the sensor data using a first data fusion to determine instantaneous aspects of the movement of the user; perform a second analysis of the instantaneous aspects using a second data fusion to determine behavioral aspects of the movement of the user over time; determine an actionable result according to the second analysis; and perform one or more operations based on the actionable result.

### BRIEF DESCRIPTION OF THE DRAWINGS

FIG. 1 illustrates an example sensor hardware system for use in performing the data pooling and analysis discussed herein;

FIG. 2A illustrates an example detail of the components of the personal electronic device;

FIG. 2B illustrates an example detail of the components of the hub;

FIG. 3A illustrates an example system architecture in which the personal electronic devices stream information from their sensors to an aggregator personal electronic device;

FIG. 3B illustrates an example system architecture in which the personal electronic devices stream information from their sensors to a wearable hub;

FIG. 3C illustrates an example system architecture in which the personal electronic devices each stream information from their sensors to an off-body hub for processing;

FIG. 4 illustrates an example data flow for the operation of the sensor hardware system;

FIG. 5A illustrates an example block diagram of the data intelligence;

FIG. 5B illustrates an example block diagram of the data intelligence where a first fusion is performed on-device and a second fusion is performed on-hub;

FIG. 5C illustrates an example block diagram of the data intelligence where the first and second fusions are performed on-hub;

FIG. 5D illustrates an example block diagram of the data intelligence performed on-hub;

FIG. 5E illustrates an example block diagram of the data intelligence showing channel state information where a first fusion is performed on-device and a second fusion is performed on-hub;

FIG. 5F illustrates an example block diagram of the data intelligence showing channel state information where the first and second fusions are performed on-hub;

FIG. 5G illustrates an example block diagram of the data intelligence showing channel state information performed on-hub;

FIG. 6 illustrates an example detail of the components of the fusion block;

FIG. 7 illustrates an example sensor transmission schedule for a plurality of sensors of the system;

FIG. 8 illustrates an example message format between the personal electronic devices and/or hub;

FIG. 9 illustrates an example device information message;

FIG. 10 illustrates an example device capability query message;

FIG. 11 illustrates an example device setup message;

FIG. 12 illustrates an example device sensor information message;

FIG. 13 illustrates an example of personal electronic devices transmitting device information messages to the hub;

FIG. 14 illustrates an example of the hub transmitting the device capability query messages to the personal electronic devices;

FIG. 15 illustrates an example of the device acting as a hub issuing device query message broadcast; and

FIG. 16 illustrates an example of ongoing transmission of the activated device sensor information messages from the personal electronic devices to the hub.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A user may have several personal electronic devices on their person. Each of the devices may be designed to perform a specific function (or set of functions). For example, earphones may be used for consuming audio from connected source devices and/or as an input microphone. A smart watch may be used for bio-marker monitoring, interface to mobile phone, activity detection, etc. A glucose monitor may monitor blood sugar levels and report back periodically to a central device. A wearable fitness tracker may count steps or calories burnt during an activity.

These devices have the capability of communicating with other devices to which they are connected. The headphones may provide audio from a connected source device, the smart watch or fitness tracker may provide time and activity data, the continuous glucose monitor may report blood sugar levels, and a multi-device wearable pose tracking system may track the pose of the person wearing them when instructed. To perform their respective functions, each of the devices may implement various sensing modalities, such as an inertial measurement unit (IMU), a pressure sensor, a temperature sensor, a wireless short-range radio, a global navigation satellite system (GNSS) receiver, a satellite communication module.

Aspects of the disclosure relate to pooling and analyzing the device generated data from the user's devices. A fusion may be performed of RF channel/communication information (including received power/signal strength, channel state information, channel impulse response, angle of arrival, range between central and peripheral, etc.) with IMU data to perform an improved activity detection.

The information that is available from these devices, such as channel state information (CSI) from the radios, raw IMU outputs, devices they have associated with, etc., can be utilized to glean more information about a user's behavior in addition to monitoring what a single device is intended to do. Collectively, the information from the sensing and communication hardware present in the devices provide rich information about the person wearing it, their actions, and their environment. This can be leveraged using machine learning at the device and/or centrally. Utilizing the insights so derived a network of such personal devices can enable additional use-cases beyond the individual target use-cases of each device. The various data in combination may be converted into actionable output utilizing machine learning techniques either on-device or at a hub (e.g., a device where the aggregated data from individual devices is available for further processing). The hub may be another on-person device, or a central off-body device with which the rest of the devices can communicate, such as a phone, laptop, tablet, desktop computer, cloud server, etc.

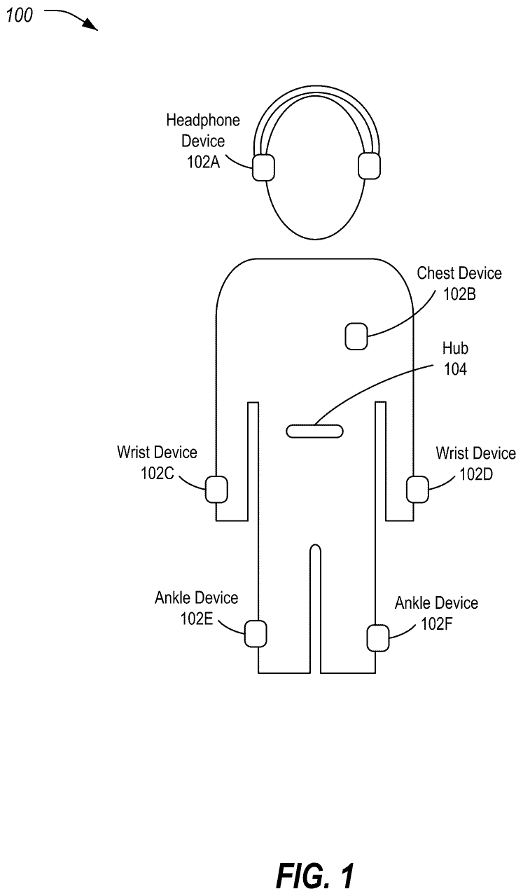

FIG. 1 illustrates an example sensor hardware system 100 for use in performing the data pooling and analysis discussed herein. The sensor hardware system 100 may include spatially distributed personal electronic devices 102 on or in the vicinity of an individual to determine various traits, actions, and activities of the individual. The sensor hardware system 100 may further include a separate hub 104 device in communication with the personal electronic devices 102 worn by the user.

The personal electronic devices 102 may be placed directly on human body (e.g., with or without a casing) or may be embedded in body worn objects such as clothing, shoes, etc. As shown, the user is wearing a headphone personal device 102A on the user's head. The user also has a chest personal device 102B located on the user's chest. The user also has wrist electronic devices 102C, 102D on each wrist and ankle electronic devices 102E, 102F on either ankle. It should be noted that these sensors 202 are merely examples, and more, fewer, or differently located personal electronic devices 102 may be used.

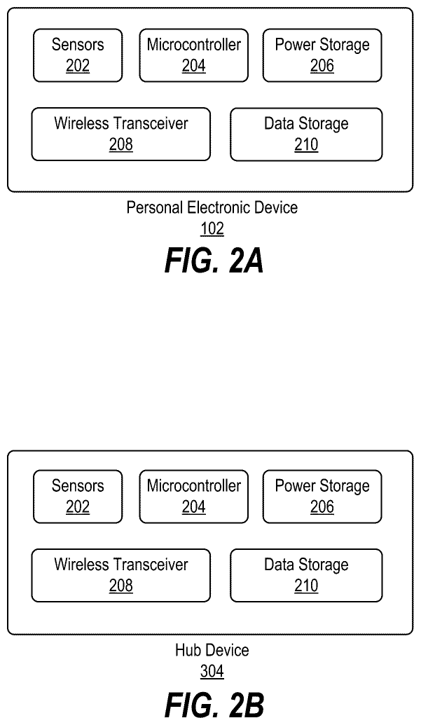

FIG. 2A illustrates an example detail of the components of the personal electronic device 102. As shown, the personal electronic device 102 may include at least one sensor 202, a microcontroller 204 including a microprocessor, memory and input/output (I/O) to connect with other peripherals, a power storage 206, a transceiver 208, and a data storage 210.

The least one sensor 202 of the personal electronic devices 102 may be configured to sense various physical phenomenon including, but not limited to, acceleration, angular velocity, magnetic heading, barometric pressure, temperature, humidity, etc. For example, the personal electronic devices 102 may include sensors 202 such as a 6 DoF (Degrees of Freedom) IMU to obtain acceleration and velocity of angular rotation, a 9 DoF IMU to obtain the Earth's magnetic field magnitude, etc.

The transceiver 208 may include communications hardware to allow an exchange of information between the personal electronic devices 102 and/or a hub 104 device. The in addition to use in sending and receiving data, the transceiver 208 may provide information with respect to inter-device relative placement, the environment, power levels utilized, direction of communication reception, etc., among others. For example, the communication between the transceivers 208 of the personal electronic devices 102 may provide information with respect to: distance between personal electronic devices 102, quality of received signal between a pair of personal electronic devices 102, radio channel state estimation representing the environment in which the personal electronic devices 102 are deployed, etc.

It should be noted that there may be multiple communication modes implemented by one or more transceiver 208 of the personal electronic devices 102. Also, the personal electronic devices 102 in the system 100 may have different communication modes among different groups. For example, an Ultra-wideband or Nearlink radio may provide distance between pairs of devices and CIR representation of the nearby environment, a Bluetooth Low Energy (BLE) or Bluetooth Classic Basic Rate (BR)/Enhanced Data Rate (EDR) radio may provide received signal strength indicator (RSSI) as a representation of the relative separation between two devices and the nature of environment between them (line of sight or blocked), Wi-Fi may provide distance between a pair of devices as well as channel frequency response (CFR) representing the environment between the devices, etc. All these representations of RF channel as perceived by the receiver like RSSI, CIR, and CFR are collectively termed as Channel State Information (CSI). CSI refers to the RF communication channel between the transmitting (on-body device) and receiving device (hub/phone/other end-point for on-body device data). The communication interfaces may also have a capability of scanning for connectable devices and the list of devices found can also be a reported information.

Referring back to FIG. 1, the hub 104 may be configured to receive and aggregate data from other personal electronic devices 102 for further processing. The hub 104 may be a separate wearable device that is worn by an individual or integrated in the personal electronic devices 102 carried by the individual. For instance, the hub 104 may be integrated into the individual's earphones, smart watch, shoes, belts, etc., or even in the fabric worn by the individual. Or, in other examples, the hub 104 may be a central off-body device with which the rest of the personal electronic devices 102 may communicate, such as a phone, laptop, tablet, desktop computer, cloud server, etc.

FIG. 2B illustrates an example detail of the components of the hub 104. Similar to the personal electronic device 102, the hub 104 may include a microcontroller 204 including a microprocessor, memory and I/O to connect with other peripherals, a power storage 206, a transceiver 208, and a data storage 210. In some examples, the hub 104 also may include at least one sensor 202.

Referring back to FIG. 1, the hub 104 may receive data from the sensors 202 of the personal electronic devices 102 and may aggregate and store the information to its data storage 210. The hub 104 may be configured to receive data from all the personal electronic devices 102; thus, mandates the hub 104 to possess at least the radio interfaces which the personal electronic devices 102 use. For example, if groups of personal electronic devices 102 in the system 100 are equipped with BLE and ultra-wideband (UWB), then at least the hub 104 may include a BLE transceiver 208 and also a UWB transceiver 208.

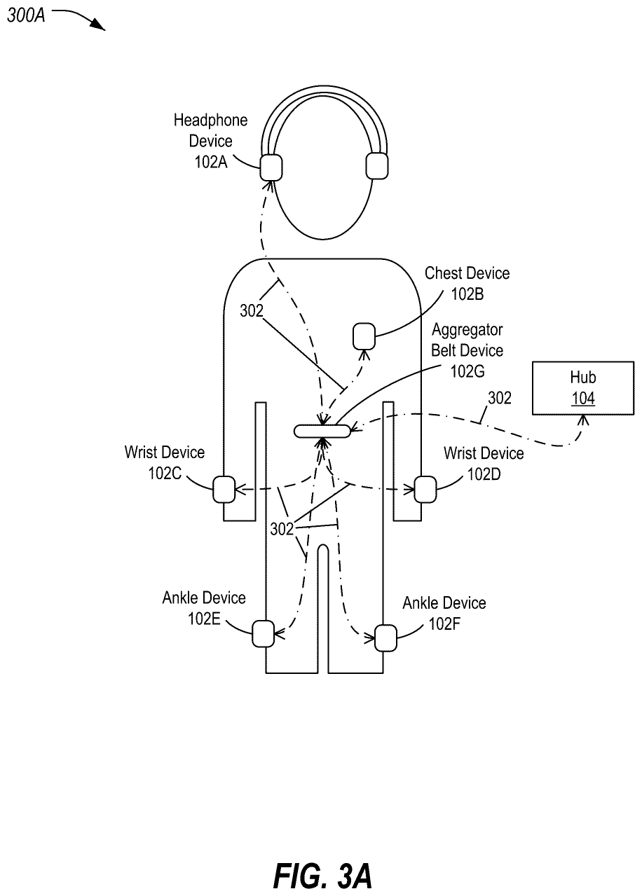

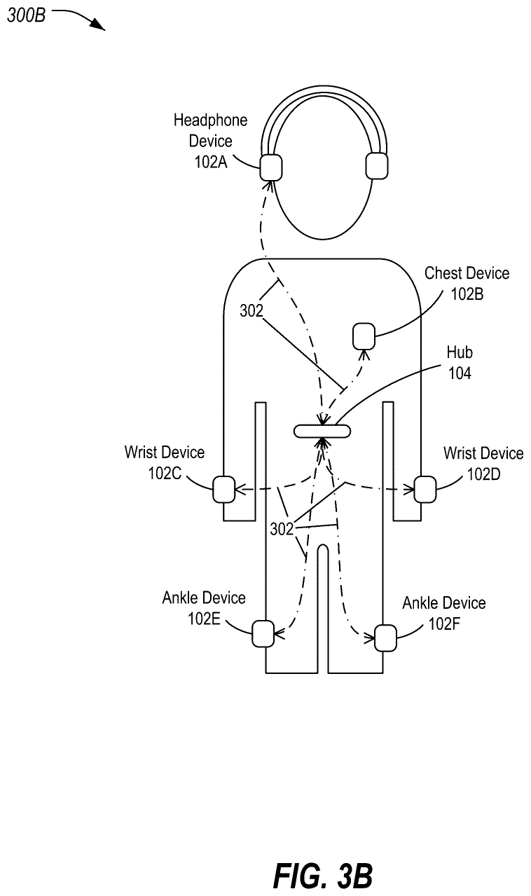

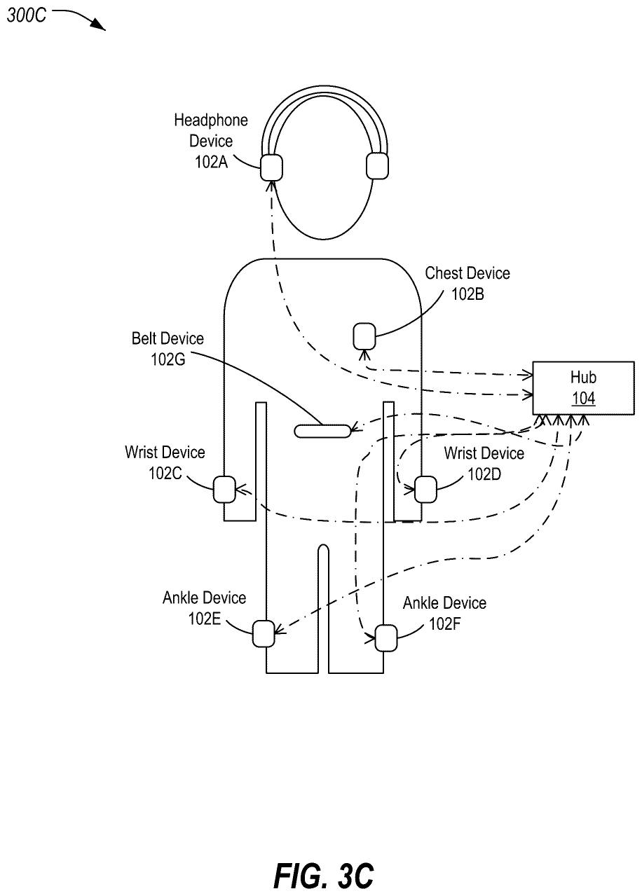

FIG. 3A illustrates an example system architecture 300A in which the personal electronic devices 102 stream information from their sensors 202 to an aggregator personal electronic device 102. In this example, the aggregator personal electronic device 102 performs an aggregation of data from the sensors 202 of the personal electronic devices 102 and streams the aggregated information to an off-body hub 104 for processing. For instance, each of the personal electronic devices 102 sends data from its sensors 202 over a respective communications link 302 to the aggregator personal electronic device 102G (here a belt mounted device but could be at any on-body location). Additionally, the aggregator personal electronic device 102G sends the aggregated data over a communications link 302 between the aggregator personal electronic device 102 and the off-body hub 104.

FIG. 3B illustrates an example system architecture 300B in which the personal electronic devices 102 stream information from their sensors 202 to a wearable hub 104 (here a belt device but could be at any on-body location). In this example, the wearable hub 104 performs both the aggregation and the processing of the data from the sensors 202. For instance, each of the personal electronic devices 102 sends data from its sensors 202 over a respective communications link 302 to the wearable hub 104.

FIG. 3C illustrates an example system architecture 300B in which the personal electronic devices 102 each stream information from their sensors 202 to an off-body hub 104 for processing. In this example, the off-body hub 104 performs both the aggregation and the processing of the data from the sensors 202. For instance, each of the personal electronic devices 102 sends data from its sensors 202 over a respective communications link 302 to the off-body hub 104.

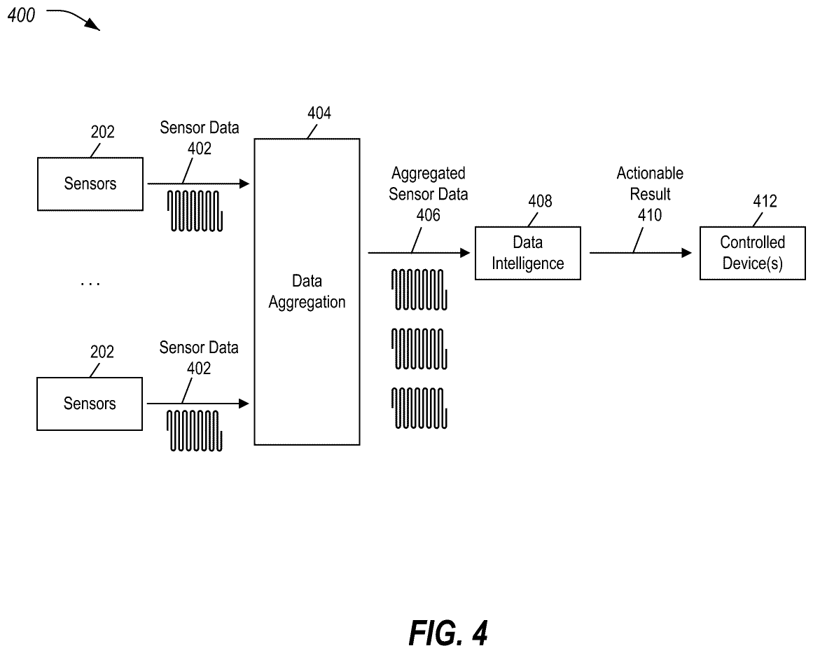

FIG. 4 illustrates an example data flow 400 for the operation of the sensor hardware system 100. As shown, sensor data 402 from different sensors 202 is collected. This may be performed by a personal electronic device 102 operating as an aggregator, and/or by the hub 104. The data aggregation 404 may include synchronizing the sensor data 402 from the different sensors 202 in time, data validation, and/or other operations to facilitate the downstream processing of the sensor data 402. The result of the data aggregation 404 is aggregated sensor data 406.

The aggregated sensor data 406 may be provided to a data intelligence block 408. As discussed in detail herein, the data intelligence block 408 may include various operations performed by the hardware of the hub 104 and/or personal electronic devices 102 to process the aggregated sensor data 406. The output of the data intelligence block 408 may include one or more actionable results 410. The one or more actionable results 410 may indicate operations to be performed by controlled devices 412 based on the analysis of the aggregated sensor data 406. The controlled devices 412 may include the personal electronic devices 102 or other devices as well.

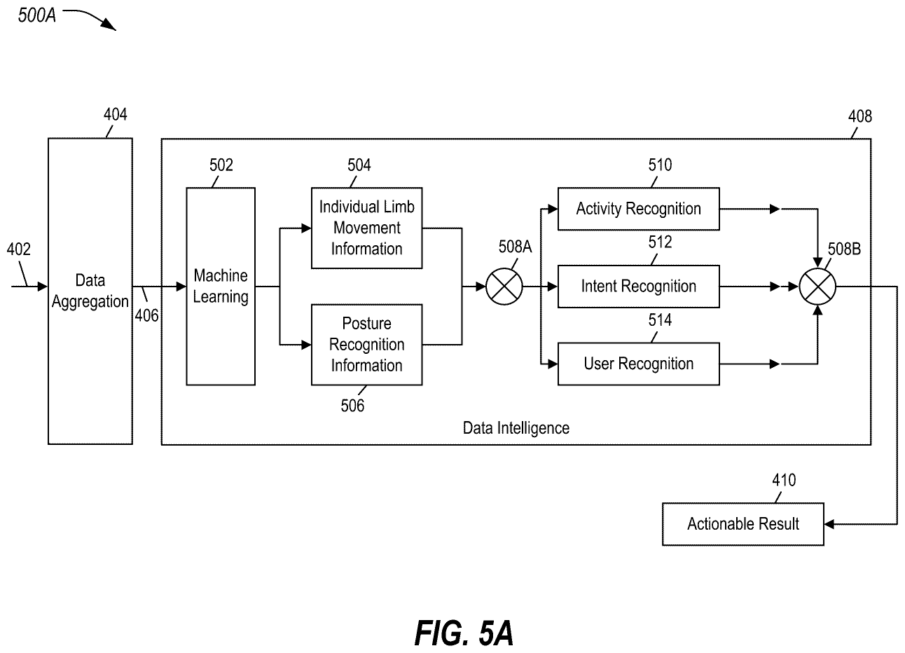

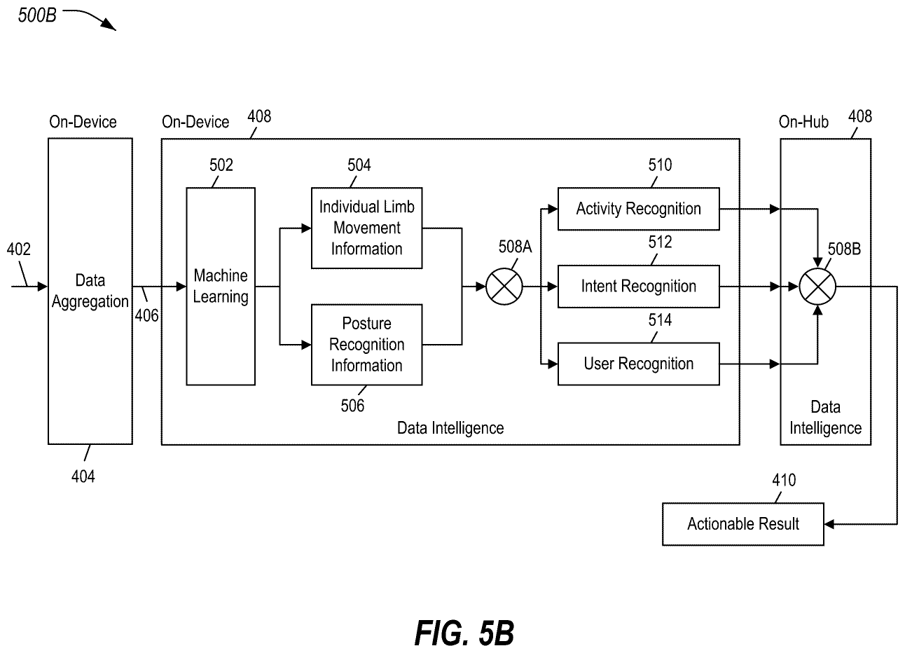

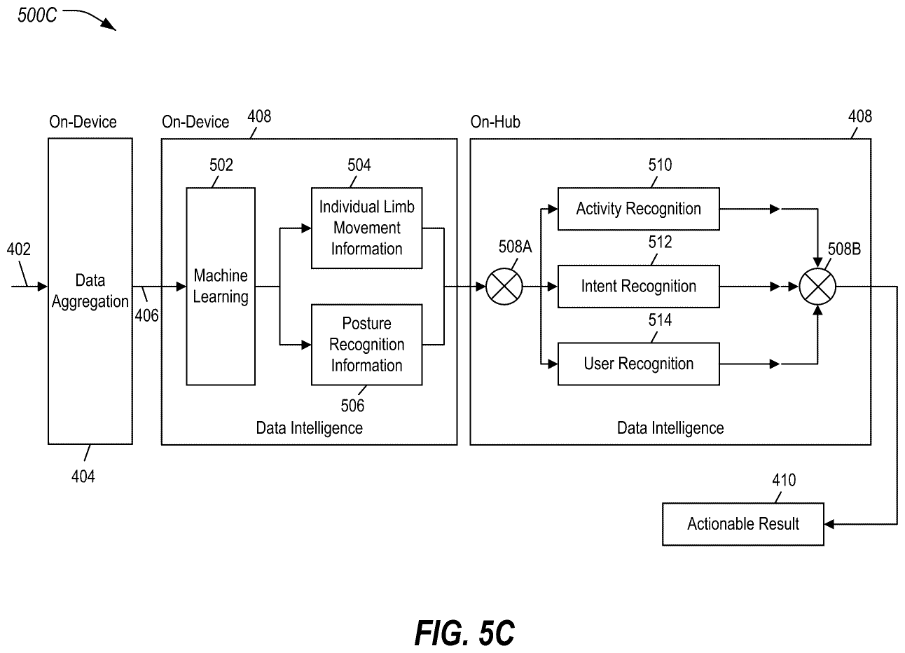

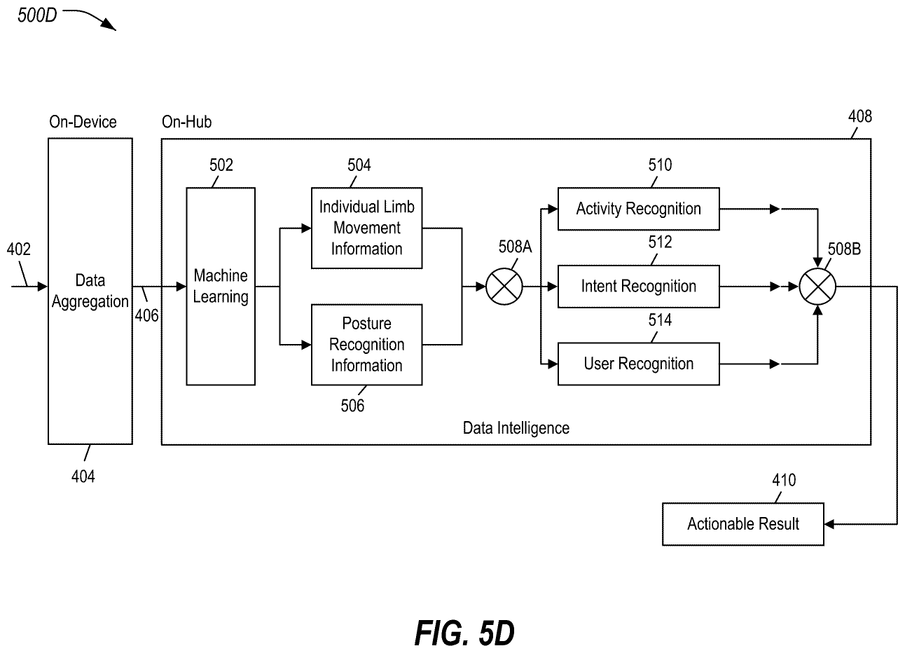

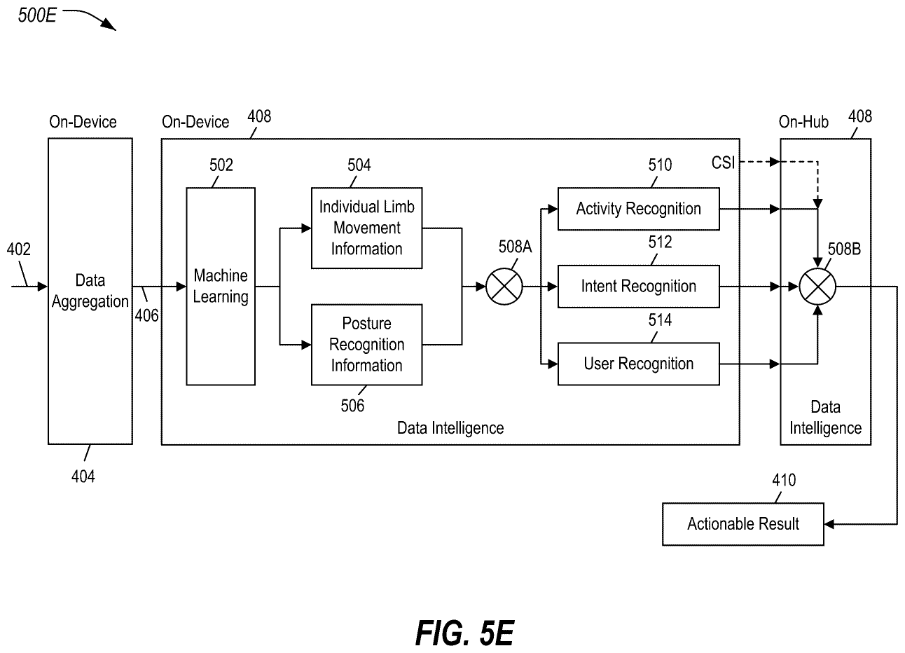

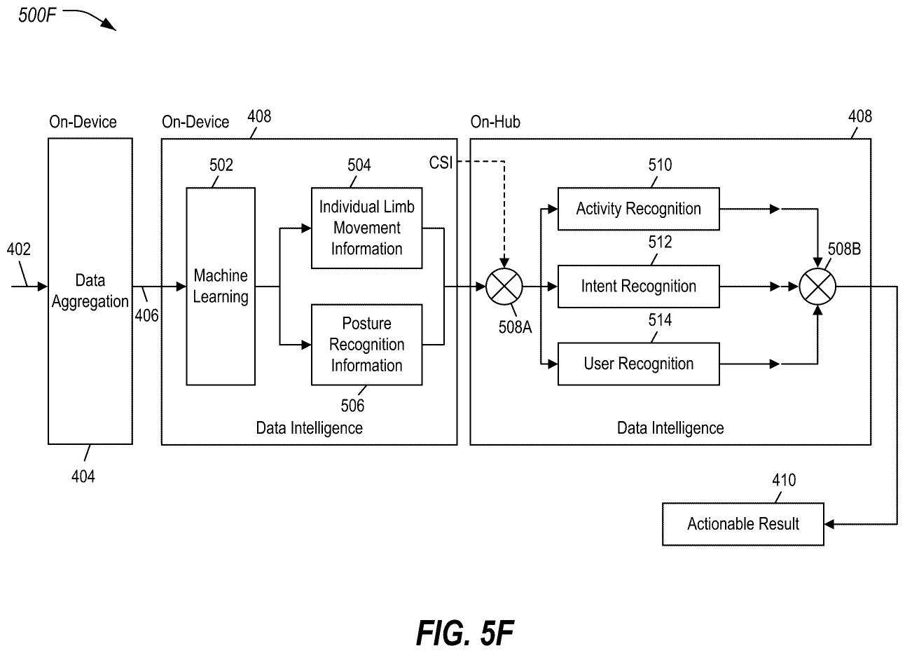

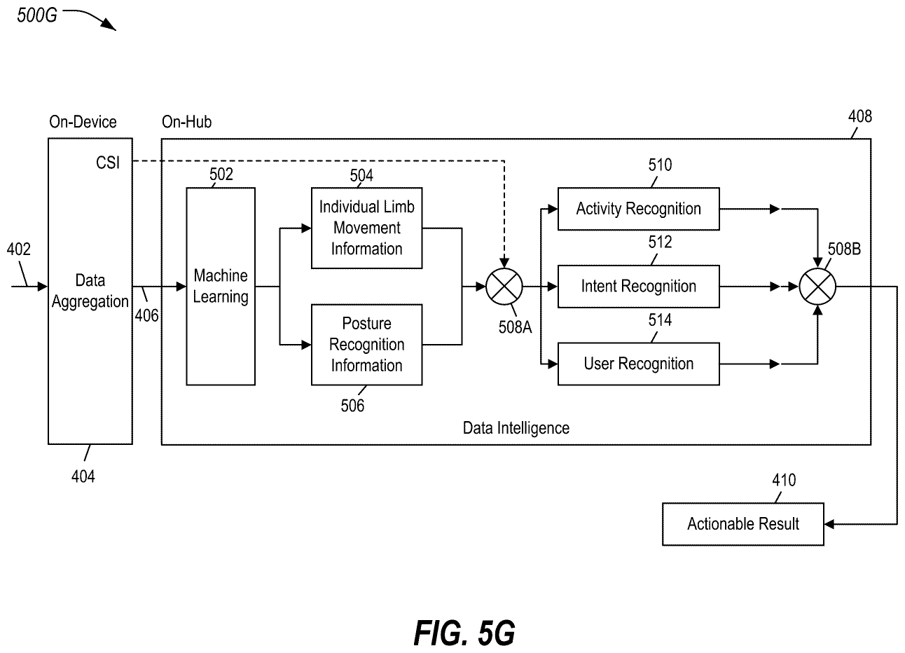

FIG. 5A illustrates an example block diagram 500A of the data intelligence block 408. As shown, as an input to the data intelligence block 408, data aggregation 404 of the incoming raw sensor data 402 may be performed. A machine learning component 502 of the data intelligence block 408 receives the aggregated sensor data 406 and/or the sensor data 402. Then, the machine learning component 502 extract a first stage of usable information from the inputs.

The first stage of data analysis via the machine learning component 502 may yield meta-information with respect to the radio environment of the personal electronic devices 102. This portion of the machine learning component 502 may in some examples be implemented on-device of the personal electronic devices 102 to extract meta-information from data-heavy reports (such as CIR data from an UWB transceiver 208, CSI for Nearlink, or CFR from a Wi-Fi transceiver 208, etc.). This meta-information about the environment may include, for example, information with respect to the presence or absence of signal interferers nearby, relative separation between the devices, etc. The machine learning component 502 may pass the meta-information to the next stage of the data intelligence block 408.

The machine learning component 502 may also perform individual limb movement recognition. This may include a determination of individual limb movement information 504 indicative of which limb the user is moving and/or the trajectory of such a movement. The individual limb movement information 504 may be fused with other information to determine higher-order actions by the user.

The machine learning component 502 may also perform posture recognition. When aggregated sensor data 406 and/or the sensor data 402 from the sensors 202 of multiple personal electronic devices 102 is available, the combined information across the multiple personal electronic devices 102 may be used for predicting an instantaneous posture of the user. This posture may be provided as posture recognition information 506.

This first stage of information, including the individual limb movement information 504 and the posture recognition information 506 may be fused using a first fusion block 508A to arrive at second stage information. The potential derived information at the second stage may include, but is not limited to, activity recognition information 510, intent recognition information 512, and user recognition information 514.

The activity recognition information 510 may indicate an immediate activity that the user is presently engaged in, such as running, walking, swimming, exercising, etc.

The intent recognition information 512 may indicate an immediate intention of the user. For example, over time the system 100 may make an observation that the user always performs a key retrieval gesture before entering a house. Coupled with activity recognition information 510 which provides a number of steps walked, or a specific number of stairs climbed, may be used to predict that the user is going to attempt entering the house. Labeling of action like entering or exiting the house may be automated based on a specific set of personal electronic devices 102 observed by involved personal electronic devices 102 to appear on entering the house or disappear on leaving the house.

The user recognition information 514 may indicate an identification of the user based on a usage pattern and relative placement of the personal electronic devices 102 on the user's person. For example, relative placement metrics of the sensor 202 of the personal electronic devices 102 along with the nature of the activity recognition information 510 being performed (e.g., how user is walking, or running, etc.) may be fused to identify the user. This follows from human kinematics which denote that every individual has a specific signature when walking, stepping, and so on.

The second stage of derived information may then be utilized in another round of fusion by a second fusion block 508B. The output of the second fusion block 508B may yield a higher-order behavior prediction of the user over time. This higher-order behavior prediction may be referred to herein as the actionable result 410. For example, if the user is identified as X and the intent is determined to be ‘about to enter a car’ then the identification of the user can be passed as an additional validation to a vehicle keyless entry system. This ensures that someone else with the user's phone cannot walk up to the car and unlock it.

FIGS. 5B-5G collectively illustrate example block diagrams of different variations of the operation of the data intelligence block 408. As noted herein, the operations performed by the data intelligence block 408 may be executed by the hardware of the personal electronic devices 102 (referred to herein as on-device) and/or on the hub 104 (referred to herein as on-hub).

As shown in the example 500B of FIG. 5B, the first stage of data analysis via the machine learning component 502 and the first fusion block 508A to arrive at second stage information are performed on-device to the personal electronic devices 102, while the second fusion block 508B is performed by the hub 104. As shown in the example 500C of FIG. 5C, the first stage of data analysis via the machine learning component 502 is performed on-device to the personal electronic devices 102, while the first fusion block 508A and second fusion block 508B are performed on-hub. As shown in the example 500D of FIG. 5D, the data aggregation 404 is performed on-device to the personal electronic devices 102, while the entirety of the data intelligence block 508 is performed at the hub 104.

FIGS. 5E-G illustrate additional examples that include the processing of CSI. As shown in the example 500E of FIG. 5E, the first stage of data analysis via the machine learning component 502 and the first fusion block 508A to arrive at second stage information are performed on-device to the personal electronic devices 102, while the second fusion block 508B is performed by the hub 104. Additionally, in the example 500E the CSI is provided from the personal electronic devices 102 to the hub 104 for consideration in the second fusion block 508B.

As shown in the example 500F of FIG. 5F, the first stage of data analysis via the machine learning component 502 is performed on-device to the personal electronic devices 102, while the first fusion block 508A and second fusion block 508B are performed on-hub. In this example 500F, the CSI is provided from the personal electronic devices 102 to the hub 104 for consideration in the first fusion block 508A.

As shown in the example 500G of FIG. 5G, the data aggregation 404 is performed on-device to the personal electronic devices 102, while the entirety of the data intelligence block 508 is performed at the hub 104. In this example 500G, the CSI is provided from the personal electronic devices 102 to the hub 104, also for consideration in the first fusion block 508A.

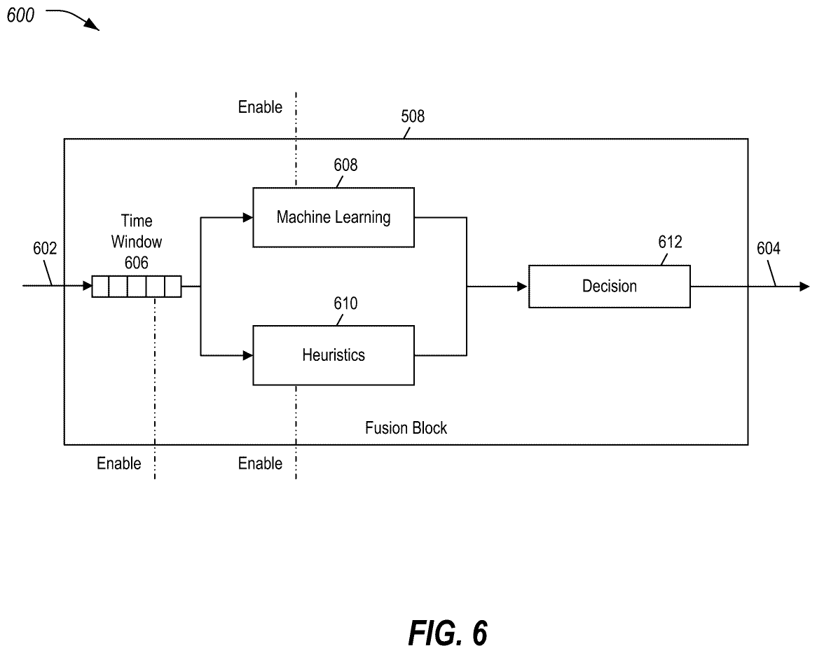

FIG. 6 illustrates an example detail of the components of the fusion block 508. The fusion block 508 may be responsible for applying processing steps on a set of input values 602 and providing a set of output values 604 that are inferred from the provided input values 602. The fusion blocks 508 may be applied at any point in the system 100. The components of the fusion block 508 include a time window component 606, a machine learning component 608, a heuristics component 610, and a decision component 612.

The time window component 606 may be configured to receive the input values 602 and apply a time window of aggregation on the set of input values 602 before performing further processing steps. The use of the time window component 606 enables upstream information applied to the fusion block 508 as the input values 602 to be analyzed with temporal context awareness, enabling higher-order inferences.

The machine learning component 608 may be configured to apply machine learning techniques to the input values 602. The machine learning component 608 may be enabled or disabled by the designer of the system 100 or as a function of upstream processing blocks, as shown by the illustrated enable line. The models executed by the machine learning component 608 to perform inference on the input values 602 may include simple classification models, such as trees, random forest, support vector machine (SVM), etc., or deep learning models such as convolutional neural networks (CNNs), transformers, liquid neural networks (LNNs), etc.

The heuristics component 610 may be configured to analyze the set of input values 602 using heuristics that are gained from domain knowledge. For example, the heuristics component 610 may apply a set of business rules in the form of an if-else-then chain on the input values 602 to categorize the information provided as an output. The heuristics component 610 may be enabled or disabled by the designer of the system 100 or as a function of upstream processing blocks, as shown by the illustrated enable line.

The decision component 612 may be configured to decides on the final output values 604 of the fusion block 508. For example, the machine learning component 608 and the heuristics component 610 of the fusion block 508 may both be activated and operating independent of one other. If both are enabled, the outputs provided by both are fed to the decision component 612 to decides on the result. Techniques used by the decision component 612 to determine the final output may include, but are not limited to, majority voting, weighting, k-means clustering, and other statistical methods.

It should be noted that in any of the components of the system 100 where machine learning is applied, continuous user interaction and system usage enables further tuning of the machine learning models. The system 100 allows pushing newer versions of the models back on to the sensors 202 and/or hubs 104 on-demand.

It should also be noted that the system 100 does not tie in the user implicitly to always share the data from the personal electronic devices 102 on their person. The user may be in full control of the visibility of such personal electronic devices 102 in the system 100. The user may choose which personal electronic devices 102 to allow into the system 100 and what data from the available modalities of the sensors 202 on the personal electronic devices 102 to use. The system 100 in turn may inform the user about the levels of service that can or cannot be enabled based on the choices.

One of the challenges in establishing a system 100 as described herein is to be able to on-board disparate group of personal electronic devices 102 on a network to be able to exchange the data elements between the personal electronic devices 102 and/or between the personal electronic devices 102 and the hub 104. Since there may be personal electronic devices 102 using different modes of communication, an approach to discover and on-board devices may operate at a higher level than physical (PHY) or medium access control (MAC) in the open systems interconnection (OSI) layer structure.

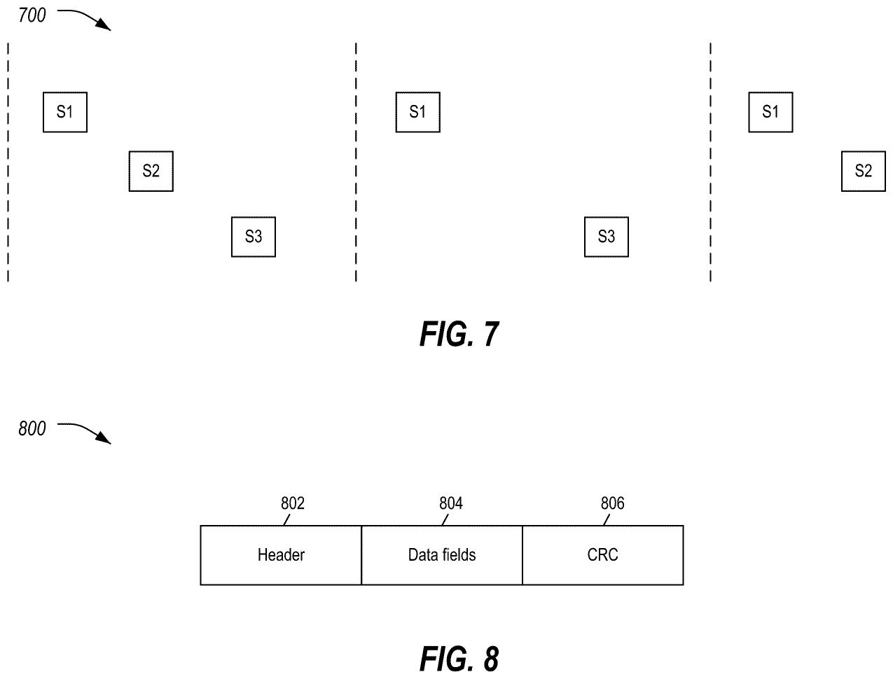

FIG. 7 illustrates an example sensor transmission schedule for a plurality of sensors 202 of the system 100. As shown, a first sensor 202, S1, transmits with a first period, frequency channel, power value, and/or antenna selection. Additionally, a second sensor 202, S2, transmits with a different period, frequency channel, power value, and/or antenna selection. Also, a third sensor 202, S3, transmits with yet another period, frequency channel, power value, and/or antenna selection.

The system 100 may be configured to utilize adaptive rate control with regards to the device data reporting intervals. For example, if an IMU sensor 202 on the personal electronic device 102 detects a sharp change with respect to steady state (state in which the personal electronic device 102 has been for a significant period) the reporting interval may be shortened, thereby providing more data for analysis. Similarly, the personal electronic device 102 may also be instructed by the hub 104 to increase the reporting interval to conserve power. Further the reporting interval itself could be a function of the activity that needs to be detected. E.g., for slower motions a high update rate may be unnecessary or redundant but for faster motions a shorter reporting interval may provide useful information. The rate variation ay also depend on the location of the sensor 202. As an example, a sensor 202 on the wrist may report in every reporting interval while a sensor 202 on the chest may report in every third reporting interval.

Another optimization that may be used by the system 100 is adaptive power control, where instead of transmitting each message at same power, subsequent messages from the sensor 202 to the hub 104 may follow a pre-determined variable transmit power pattern to enhance the accuracy of RF-based activity detection.

In another example, similar to the adaptive power control, instead of transmitting at same frequency channel, subsequent messages from the sensor 202 to the hub 104 may follow a pre-determined variable transmit frequency channel power pattern to enhance the accuracy of RF based activity detection. While BLE frequency hopping may be built into the protocol, setting a pre-determined pattern may still increase accuracy. For other technologies, a frequency hopping pattern may be explicitly provided by the hub 104 to the personal electronic devices 102.

In yet another example, multiple antennas may be used at the sensor 202 and/or the hub 104, and each of those antennas may be used as a separate training chains and benefit from antenna diversity. The choice of antenna use may also depend on the activity, where some activities are given preference on antenna choice as one possibility.

One option for selection of optimal RF parameters (e.g., power, channel, antenna) may include a sample communication exchange between the personal electronic devices 102 and the hub 104 in the beginning of activity detection.

FIG. 8 illustrates an example message format 800 between the personal electronic devices 102 and/or hub 104. As shown, the message format 800 includes a header 802, data fields 804, and a cyclic redundancy check (CRC) 806. The header 802 may include identifying information with respect to the messages being sent, the data fields 804 may include the application level-content of the messages, and the CRC 806 may indicate parity or other check information to ensure that the message is not corrupted.

Messages may be formed in the message format 800 to define standard messages between the personal electronic devices 102 and hub 104. These messages may be transported using various lower-level communication constructs (Wi-Fi, BLE, UWB, Nearlink, other low power wireless networking protocols, etc.) to form an application-level network of devices. The set of such messages may be referred to herein as a Cooperative Device Sensor Information Exchange Network (CoDeSInExNet) Profile.

While FIG. 8 shows a general structure of messages exchanged in the system 100, specific illustrative examples are provided along with the description of individual messages are discussed next.

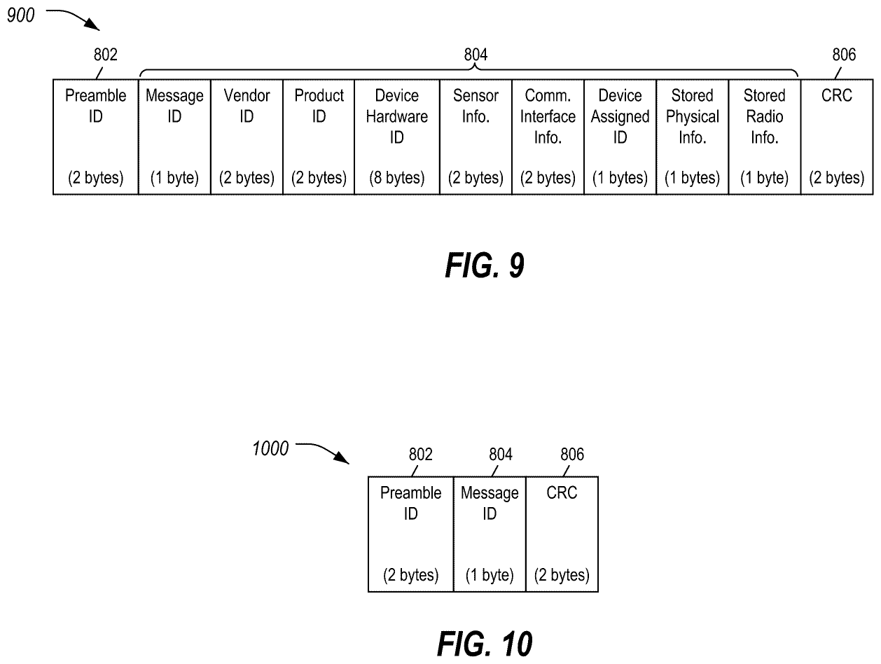

FIG. 9 illustrates an example device information message 900. The device information message 900 may be exchanged between the personal electronic devices 102 and the hub 104 during general network device discovery over any or all available communication interfaces. The device information message 900 formats may be implementation-dependent; however, the information about the sensors 202 and communication interfaces may be included in the data fields 804 of the device information message 900.

The device information message 900 provides information about the message type, device identification information including vendor id, product id, device hardware id, etc. Depending on the protocol, the fields of the device information message 900 may be embedded in the communication protocol device discovery messages between the personal electronic devices 102 and the hub 104.

Another portion of the information conveyed by the device information message 900 is information about the sensors 202 that are available for the communicating personal electronic device 102. Additionally, the information may indicate the communication modes that are available via the personal electronic device 102 (this may include Wi-Fi, BLE, UWB, etc.). If the personal electronic device 102 was configured for the system 100 earlier, the previous information is also made available as part of this message.

On receiving the device information message 900, the end-point (e.g., personal electronic devices 102 and/or the hub 104) may parse the information and provide this information to the user interface for validation of existing settings or for configuring with new settings (for example, if the user has mistakenly worn the headphones for the left ear in the right ear then this can be corrected; or if a new personal electronic devices 102 is used by the user then it can be configured for the system 100).

FIG. 10 illustrates an example device capability query message 1000. The device capability query message 1000 may be broadcast by a personal electronic device 102 and/or by the hub 104. A device that receives this message may reply with a device information message 900 over the communication interfaces on which it received the device capability query message 1000, to the same source device which sent the broadcast.

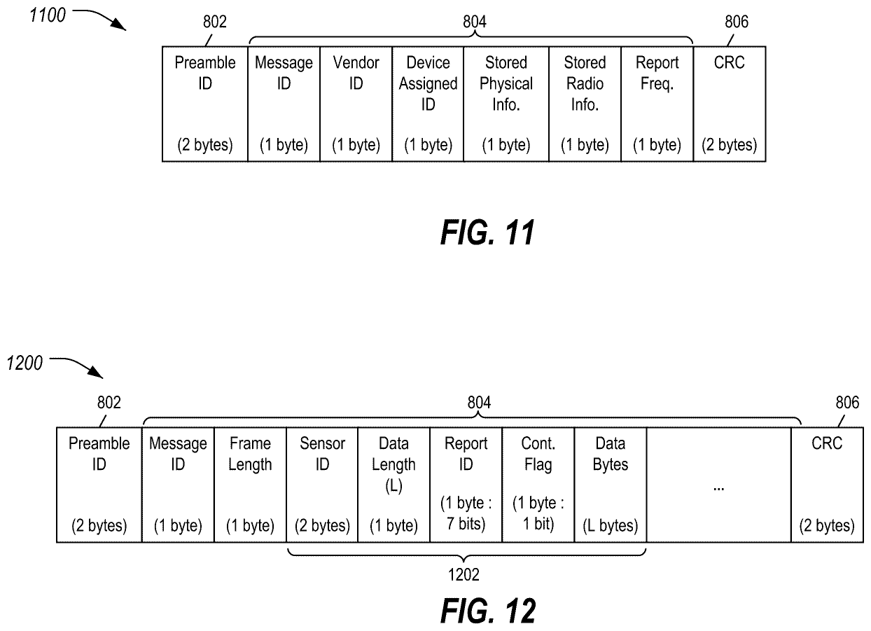

FIG. 11 illustrates an example device setup message 1100. The device setup message 1100 may be sent over the communication interface(s) over which the hub 104 established connection with the end device (e.g., the personal electronic device 102). The user provides the sensors 202 to monitor, the radio interfaces to use for information exchange, and the reporting frequency for the end device. The message should include reporting frequency as the minimum data field 804.

FIG. 12 illustrates an example device sensor information message 1200. The device sensor information message 1200 may be sent from the personal electronic device 102 to the device operating as the hub 104, at a set reporting interval. The sensor data 402 contained in the device sensor information message 1200 is the collected data between the last reporting and current time for all the active sensors 202 on the personal electronic device 102 as set by the device setup message 1100. As shown the sensor data 402 from a single sensor 202 is included in the example device sensor information message 1200, but it should be noted that multiple sections of sensor data 402 may be included in the device sensor information message 1200, space permitting. In some examples, the sensor data 402 may be too large for a single device sensor information message 1200 and may span multiple such device sensor information messages 1200.

The data from individual sensors 202 contain a timestamp for temporal alignment at the device operating as the hub 104. A common time base can be established by any time synchronization protocols active in the network. If a communication protocol message and a device sensor information message 1200 send times overlap, preference is given to the communication protocol message and the device sensor information message 1200 is sent at the next available opportunity. This data packet could include data from multiple sensors 202 on the personal electronic device 102 in one message or in separate messages. This should at the minimum include data length in bytes and accordingly sensor data 402 for each sensor 202 of the personal electronic device 102.

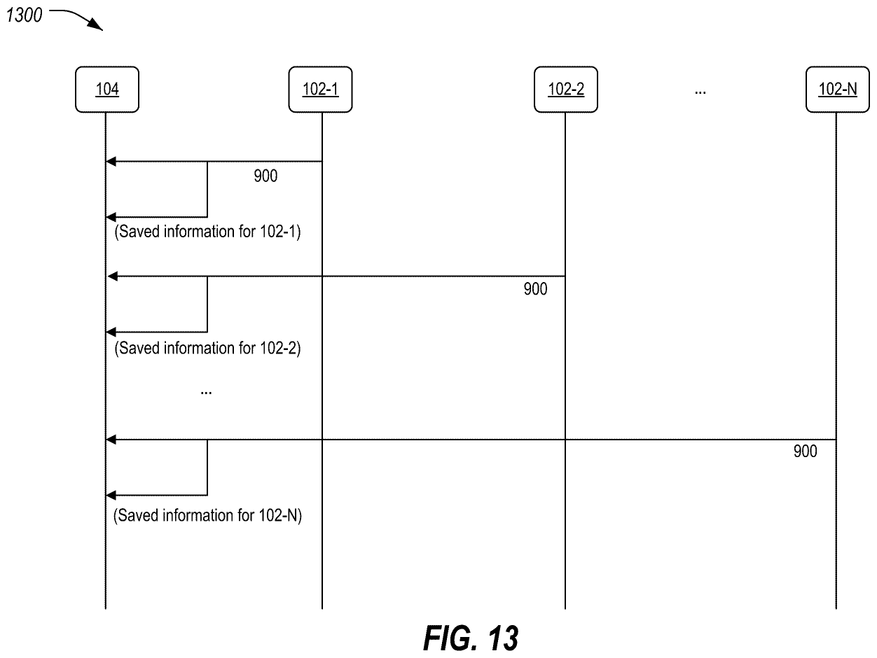

FIGS. 13-16 illustrate an example message protocol using the device information messages 900, device capability query messages 1000, device setup messages 1100, and device sensor information messages 1200.

FIG. 13 illustrates an example 1300 of personal electronic devices 102-1 through 102-N transmitting device information messages 900 to the hub 104. These device information messages 900 indicate the device-specific interfaces and capabilities information of the respective personal electronic devices 102-1 through 102-N. This may be performed during a phase of the message protocol where the personal electronic devices 102-1 through 102-N are advertising to join a network. The device operating as the hub 104 may save the information received in the device information messages 900.

When the user actuates the system 100, the data about the personal electronic devices 102-1 through 102-N may be presented with any past configuration information. In some examples, the user may decide to re-configure the personal electronic devices 102-1 through 102-N at will and a new configuration is generated. In other cases, the old configuration is deemed acceptable and is reused.

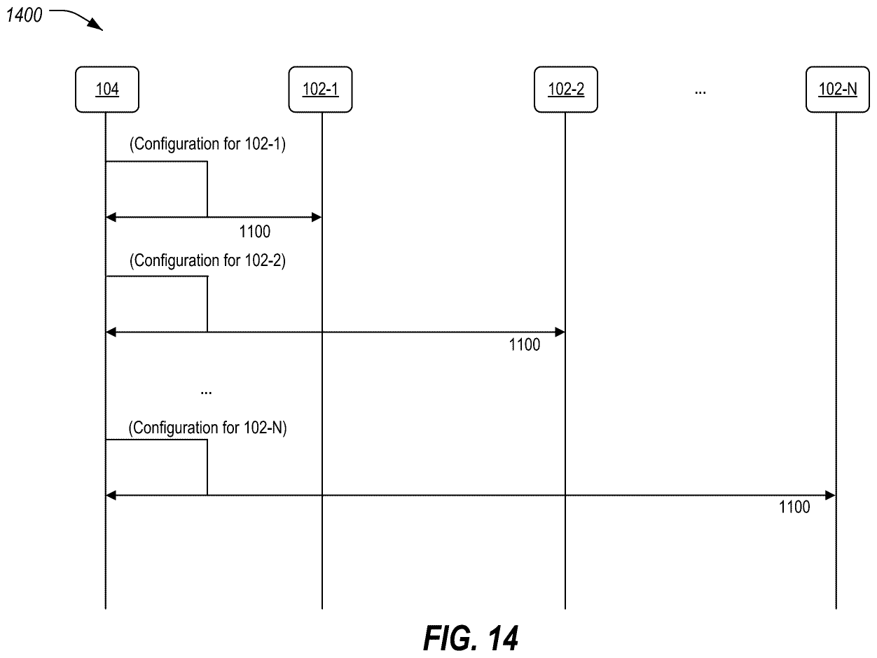

FIG. 14 illustrates an example 1400 of the hub 104 transmitting the device capability query messages 1000 to the personal electronic devices 102-1 through 102-N. As shown, the device operating as the hub 104 device is connected to the personal electronic devices 102-1 through 102-N. The user has requested a personal electronic device 102 to be in the system 100 and provided a configuration for it. The configuration may indicate, for example a cadence for receiving sensor data 402 and/or information on what sensor data 402 is desired by the hub 104. This may be communicated over the connected link(s) to the personal electronic devices 102-1 through 102-N using the device setup messages 1100.

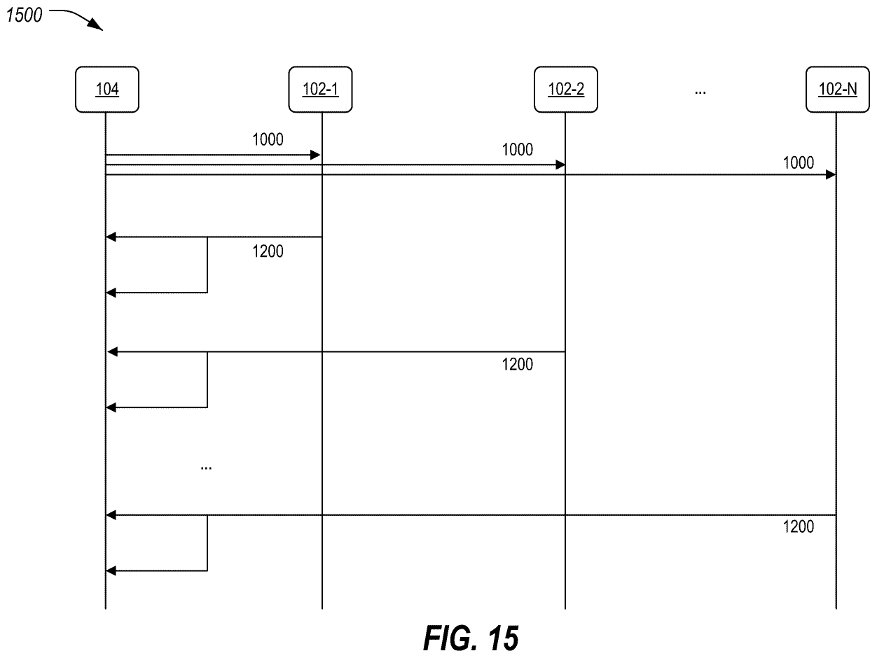

FIG. 15 illustrates an example 1500 of the device acting as a hub 104 issuing a device query message broadcast 1502. The personal electronic devices 102-1 through 102-N receiving this message may respond with device sensor information message 1200 destined for the source of the device query message broadcast 1502.

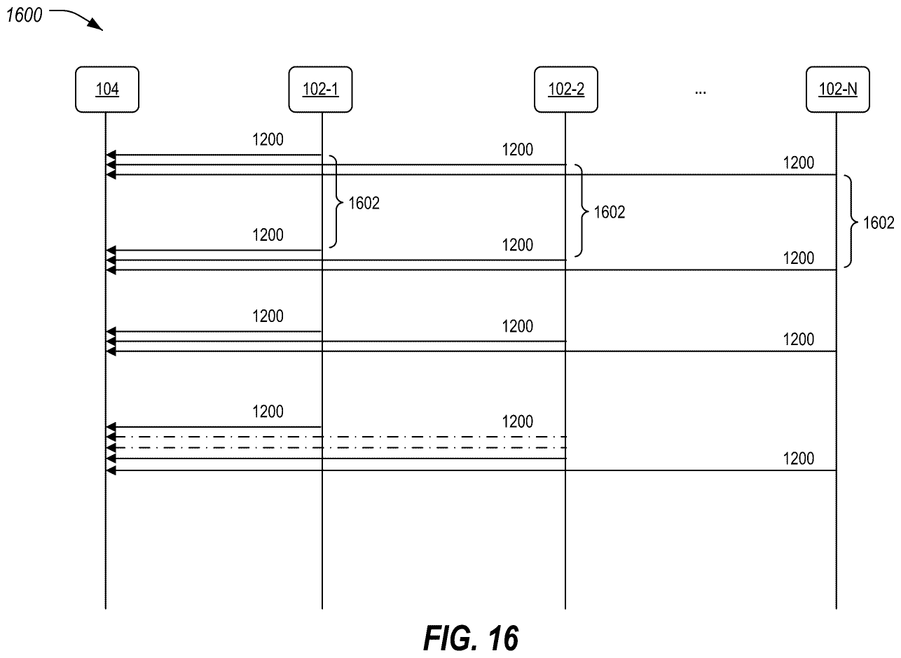

FIG. 16 illustrates an example 1600 of ongoing transmission of the activated device sensor information messages 1200 from the personal electronic devices 102-1 through 102-N to the hub 104. Once the personal electronic devices 102-1 through 102-N are connected and configured to be a source of information in the system 100, the personal electronic devices 102-1 through 102-N transmit, over the configured communication interfaces, data collected from the enabled sensors 202.

The frequency of such updates is shown in the example 1600 as the reporting interval 1602. This reporting interval 1602 may have been previously decided during the setup stage noted above. If one of the transmit event times of the reporting interval 1602 overlaps or clashes with a communication protocol event, then the communication protocol event takes precedence. The conflicting messages are shown by the dot-dashed arrows. Once the communication protocol event is complete, then the device sensor information message(s) 1200 are sent out. Each of the reports from the sensors 202 within a device sensor information message 1200 has a timestamp that may be used to temporally align the messages at the device operating as the hub 104.

Thus, personal electronic devices 102 may stream their information directly to an off-body device such as mobile phone, laptop, etc., (as in FIG. 3A) or to a central hub 104 on-body (as shown in FIG. 3B) or to an off-body device via an on-body hub/aggregator/bridge (as shown in FIG. 3C). Data from sensors 202 of the personal electronic devices 102, along with other available inputs, may be analyzed using machine learning algorithms to determine several factors about the current state of the individual. When the system 100 observes such state changes of the individual over time determination can be made about the intent of the individual along with establishing a signature that helps identify the individual and the environment, they may be in.

The disclosed system 100 can be applied in various user cases. As some automotive examples, the system 100 may be used for occupancy detection; occupant identification; gait recognition; gestures; activity detection; as an additional input to existing systems such as keyless entry; intent recognition. As some building examples, the system 100 may be used for gait recognition; occupancy detection; activity detection; intent recognition; patient activity monitoring in hospitals, elderly wellness monitoring in care facilities, etc. As some health and fitness examples, the system 100 may be used for consumer activity monitoring; activity recognition; intent recognition; condition monitoring; and monitoring vital signs.

Computing devices such as those discussed herein generally include computer-executable instructions, where the instructions may be executable by one or more computing devices 702. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for performing data pooling and analysis, comprising:
receiving, by a hub, sensor data streamed from a plurality of personal electronic devices worn by a user;
performing a first analysis of the sensor data using a first data fusion to determine instantaneous aspects of the movement of the user;
performing a second analysis of the instantaneous aspects using a second data fusion to determine behavioral aspects of the movement of the user over time;
determining an actionable result according to the second analysis; and
performing one or more operations based on the actionable result.

2. The method of claim 1, wherein the sensor data includes inertial measurement unit (IMU) data from one or more IMU sensors of the plurality of personal electronic devices.

3. The method of claim 2, wherein the IMU data includes acceleration and/or velocity information with respect to movement of the user.

4. The method of claim 1, wherein the sensor data includes radio frequency (RF) channel information data from one or more RF transmitters of the plurality of personal electronic devices.

5. The method of claim 4, wherein the RF channel information data indicates one or more of distances between pairs of the plurality of personal electronic devices and channel state information (CSI) representative of the environment between the plurality of personal electronic devices.

6. The method of claim 1, wherein the instantaneous aspects include one or more of user traits, posture, actions, and/or activities.

7. The method of claim 1, wherein the behavioral aspects include one or more of user intent determination and/or person identification.

8. The method of claim 7, wherein the actionable result includes authorizing the user to access a device or location based on the user intent determination and the person identification.

9. The method of claim 1, wherein the plurality of personal electronic devices include one or more of headphones, a biometric device, a smart watch, and/or a mobile phone.

10. The method of claim 1, further comprising:
identifying, by the hub, the plurality of personal electronic devices based on advertisement messages sent by the respective personal electronic devices;
receiving, to the hub, device information messages from the plurality of personal electronic devices, the device information messages indicating device-specific interfaces and capabilities of the respective personal electronic devices; and
sending, by the hub, configurations to the plurality of personal electronic devices, the configurations indicating a cadence for receiving the sensor data and/or information on which elements of the sensor data is to be provided to the hub.

11. The method of claim 1, further comprising:
broadcasting, by the hub, a device query message broadcast requesting that the plurality of personal electronic devices send device sensor information messages to the hub;
receiving, by the hub, the device sensor information messages requested from the plurality of personal electronic devices; and
continuing to receive periodic device sensor information messages from the plurality of personal electronic devices.

12. The method of claim 11, wherein the plurality of personal electronic devices defer sending the periodic device sensor information messages if there is a conflict with protocol messages being sent or received by the plurality of personal electronic devices.

13. A system for performing data pooling and analysis, comprising:
a plurality of personal electronic devices worn by a user, the plurality of personal electronic devices configured to generate sensor data with respect to the user; and
a hub device in wireless communication with the plurality of personal electronic devices,
wherein the plurality of personal electronic devices and the hub device are configured to:
perform a first analysis of the sensor data using a first data fusion to determine instantaneous aspects of the movement of the user,
perform a second analysis of the instantaneous aspects using a second data fusion to determine behavioral aspects of the movement of the user over time,
determine an actionable result according to the second analysis, and
perform one or more operations based on the actionable result.

14. The system of claim 13, wherein the sensor data includes inertial measurement unit (IMU) data from one or more IMU sensors of the plurality of personal electronic devices.

15. The system of claim 14, wherein the IMU data includes acceleration and/or velocity information with respect to movement of the user.

16. The system of claim 13, wherein the sensor data includes radio frequency (RF) channel information data from one or more RF transmitters of the plurality of personal electronic devices.

17. The system of claim 16, wherein the RF channel information data indicates one or more of distances between pairs of the plurality of personal electronic devices and channel state information (CSI) representative of the environment between the plurality of personal electronic devices.

18. The system of claim 13, wherein the instantaneous aspects include one or more of user traits, posture, actions, and/or activities.

19. The system of claim 13, wherein the behavioral aspects include one or more of user intent determination and/or person identification.

20. The system of claim 19, wherein the actionable result including authorizing the user to access a device or location based on the user intent determination and the person identification.

21. The system of claim 13, wherein the plurality of personal electronic devices include one or more of headphones, a biometric device, a smart watch, and/or a mobile phone.

22. The system of claim 13, wherein the hub is further configured to:
identify, by the hub, the plurality of personal electronic devices based on advertisement messages sent by the respective personal electronic devices;
receive, to the hub, device information messages from the plurality of personal electronic devices, the device information messages indicating device-specific interfaces and capabilities of the respective personal electronic devices; and
send, by the hub, configurations to the plurality of personal electronic devices, the configurations indicating a cadence for receiving the sensor data and/or information on which elements of the sensor data is to be provided to the hub.

23. The system of claim 13, wherein the hub is further configured to:
broadcast, by the hub, a device query message broadcast requesting that the plurality of personal electronic devices send device sensor information messages to the hub;
receive, by the hub, the device sensor information messages requested from the plurality of personal electronic devices; and
continue to receive periodic device sensor information messages from the plurality of personal electronic devices.

24. The system of claim 23, wherein the plurality of personal electronic devices defer sending the periodic device sensor information messages if there is a conflict with protocol messages being sent or received by the plurality of personal electronic devices.

25. One or more non-transitory computer-readable mediums comprising instructions for performing data pooling and analysis that, when executed by system including a hub device and a plurality of plurality of personal electronic devices, cause the system to perform operations including to:
capture sensor data streamed from a plurality of personal electronic devices worn by a user;
perform a first analysis of the sensor data using a first data fusion to determine instantaneous aspects of the movement of the user;
perform a second analysis of the instantaneous aspects using a second data fusion to determine behavioral aspects of the movement of the user over time;
determine an actionable result according to the second analysis; and
perform one or more operations based on the actionable result.
